(19) United States
(12) Patent Application Publication
(10) Pub. No.: US 2012/0273056 A1
(43) Pub. Date: Nov. 1, 2012

(54) BARRIER COMPOSITION

(76) Inventor: Keith Donald Woodford, Aberdeenshire (GB)

(21) Appl. No.: 13/504,712

(22) PCT Filed: Oct. 27, 2010
(86) PCT No.: PCT/GB10/01983

§ 371 Date: Jul. 16, 2012

(51) Int. Cl. G05D 16/18; F04B 49/00; F04B 9/10

(52) U.S. Cl. 137/14; 417/213

(57) ABSTRACT

A pressure control system (10) comprises a pressure modulating arrangement (14) adapted to be operated by a drive medium to modulate the pressure of a product fluid at a target location (12) towards a target pressure. The control system (10) also comprises a control device (22) configured to monitor at least one reference pressure and to control the drive medium being delivered to the pressure modulating arrangement (14) in accordance with said at least one reference pressure.

### FIELD OF THE INVENTION

The present invention relates to a pressure control system for use in controlling the pressure of a fluid at a target location, and in particular, but not exclusively, at a number of locations.

### BACKGROUND TO THE INVENTION

Many applications require fluid to be delivered to a target location at a controlled pressure. For example, in some sealing arrangements a physical seal barrier is supported by a fluid, such as a lubricant, supplied at pressure to a seal chamber behind the barrier. The fluid may be supplied to the seal chamber at a pressure appropriate to the seal application. For example, lubricant may be provided at a pressure which is substantially equivalent, proportional or otherwise related to a pressure to be contained by the seal.

In some sealing arrangements a number of seal barriers may be provided with a corresponding number of seal chambers formed therebetween. Each adjacent seal chamber may receive a sealing fluid at a reduced pressure such that the entire pressure differential is accommodated in a cascading staged manner across the entire seal arrangement. It is important to ensure that the required pressure differential across the seal arrangement is distributed proportionally between each chamber. Accordingly, a robust pressure control arrangement must be provided in order to ensure that the individual sealing stages may be configured appropriately for the particular application.

### SUMMARY OF THE INVENTION

According to a first aspect of the present invention there is provided a pressure control system comprising:

a pressure modulating arrangement adapted to be operated by a drive medium to modulate the pressure of a product fluid at a target location towards a target pressure; and

a control device configured to monitor at least one reference pressure and to control the drive medium being delivered to the pressure modulating arrangement in accordance with said at least one reference pressure.

In use, the control device may control the drive medium in accordance with the at least one reference pressure to permit the pressure modulating arrangement to modulate the pressure of the product fluid towards a target pressure.

The pressure control system may be configured to initially establish a target pressure of a product fluid at a target location. The pressure control system may be configured to continuously modulate the pressure of the product fluid to maintain a target fluid pressure.

The target fluid pressure may comprise a predetermined pressure, such as a predetermined fixed pressure, predetermined variable pressure or the like. The target fluid pressure may be predetermined in accordance with, for example, an intended end use or the like.

The target pressure may be determined in accordance with at least one monitored reference pressure. The pressure control system may be configured to modulate the pressure at the target location to track the monitored reference pressure. The target pressure may be substantially equivalent to at least one monitored reference pressure. The target pressure may be proportional to at least one monitored reference pressure. The target pressure may differ from the reference pressure by a predetermined value, which may be fixed or variable. The target pressure may be larger, or smaller than at least one monitored reference pressure. The target pressure may be variable in accordance with variations in at least one monitored reference pressure.

The control device may comprise an electrical control device. The control device may comprise a mechanical control device.

The control device may be configured to monitor at least one reference pressure stored by the pressure control system, for example stored by the control device. in this arrangement the control device may monitor the stored reference pressure and control the drive medium being delivered to the pressure modulating arrangement accordingly. The stored reference pressure may be stored electronically by the pressure control system, for example within a memory device associated with, or forming part of, the control device. The stored reference pressure may be fluidly stored within a conduit, pressure vessel, such as a calibrated pressure vessel associated with the control device, or the like.

The control device may be configured to monitor at least one reference pressure at a reference location. The reference location may be remote from the target location. The reference location may be associated with an environment which contains the target location.

The control device may be configured to monitor the pressure at the target location. The control device may be configured to control the drive medium in accordance with the monitored pressure at the target location and a monitored reference pressure. The control device may be configured to control the drive medium in accordance with a pressure differential between the monitored pressure at the target location and a monitored reference pressure.

The control device may be configured to modify a monitored pressure in accordance with a desired bias. For example, the control device may be configured to modify a monitored pressure, such as a monitored pressure at the target location, monitored reference pressure or the like, by effectively adding or removing a bias. The bias may be generated by, for example, direct fluid pressure, a mechanical force or the like. The bias may be achieved electronically. The desired bias may be fixed, variable or the like. This arrangement may permit the control device to control the drive medium to achieve a target pressure at the target location which differs from a monitored reference pressure by a predetermined bias value.

The pressure control system may further comprise a variable controller configured to vary the drive medium being delivered to the pressure modulating arrangement. The variable controller may be controlled by the control device. The variable controller may form part of the control device.

The control device may be configured to generate a control signal to permit appropriate control of the drive medium. The control signal may comprise an electrical signal, pressure signal or the like. The control device may be configured to communicate a control signal to a variable controller to permit appropriate control of the drive medium.

The control device may be configured to generate a mechanical output to permit appropriate control of the drive medium. The control device may be configured to generate a mechanical output to a variable controller. In one embodiment the control device may comprise a mechanical assembly having a displaceable component configured to be displaced to control the variable controller. The displaceable component may be configured to be displaced by exposure to a pressure. The displaceable component may be configured to be displaced by exposure to a monitored reference pressure, monitored pressure at a target location or the like. The displaceable component may be configured to be displaced by exposure to a pressure differential, for example by a pressure differential between a monitored pressure at the target location and a monitored reference pressure.

The control device may comprise a piston assembly having a displaceable piston component. The displaceable piston component may comprise a piston area configured for exposure to a pressure, such as a monitored reference pressure, monitored pressure at the target location or the like. In one embodiment the displaceable piston component may comprise a first piston area configured for exposure to a monitored reference pressure, and a second piston area configured for exposure to a monitored pressure at the target location. The first and second piston areas may be similar. Alternatively, the first and second piston areas may be dissimilar. Dissimilar piston areas may permit a biasing effect to be established by the piston assembly. A differential between pressures and/or piston areas may permit displacement of the piston component.

The control device may comprise a biasing arrangement configured to bias a displaceable component. The biasing arrangement may be configured to apply a biasing force on the displaceable component. The biasing force may be provided by a pressure force. The biasing force may be provided by a mechanical force, such as by a spring force or the like. The biasing force may be provided by a differential piston area associated with the displaceable component.

The drive medium may comprise a fluid, wherein the control device is configured to control a property of said fluid, such as fluid pressure, flow rate or the like. The drive fluid may comprise a liquid or gas. In this arrangement the pressure modulating arrangement may be fluid actuated.

The drive medium may comprise an electrical output, such as an electrical current, voltage, frequency or other such outputs, wherein the control device is configured to control the electrical output. In this arrangement the pressure modulating arrangement may be electrically actuated.

The pressure modulating arrangement may be configured to increase the pressure at the target location. The pressure modulating arrangement may be configured to decrease the pressure at the target location, for example by permitting relief of pressure from the target location.

The product fluid may be contained between the target location and the pressure modulating arrangement. For example, the product fluid may be contained within a conduit, flow path or the like between the target location and the pressure modulating apparatus.

The pressure modulating arrangement may be positioned between a source of product fluid and the target location. The pressure modulating arrangement may be configured to permit flow of product fluid from the product fluid source towards the target location, for example to increase the pressure at the target location. The pressure modulating arrangement may be configured to permit flow of the product fluid from the target location to the product fluid source, for example to relieve pressure at the target location. Providing fluid communication with a product fluid source may permit replenishment of product fluid at the target location, which may be required due to leakage, for example leakage at the target location.

The pressure modulating arrangement may comprise at least one pressure modulating device.

At least one pressure modulating device may be configured to increase the pressure at the target location. This may permit the at least one pressure modulating device to increase the pressure at the target location when said pressure is below the target pressure.

At least one pressure modulating device may be configured to decrease or relieve pressure at the target location. This may permit the at least one pressure modulating device to reduce the pressure at the target location when the pressure at the target location is above the target pressure.

At least one pressure modulating device may be configured to both increase and decrease pressure at the target location.

The pressure modulating arrangement may comprise at least one pressure modulating device configured to increase the pressure at the target location and at least one pressure modulating device configured to decrease the pressure at the target location.

At least one pressure modulating device may comprise a pump assembly, such as a positive displacement pump assembly, rotodynamic pump assembly or the like. It should be understood that the term pump is used to encompass devices which can apply energy to different fluids, including liquids and gases. Accordingly, the term pump as used herein is intended to include devices such as liquid pumps, gas compressors, multiphase pumps and the like.

In one embodiment at least one pressure modulating device may be actuated by a fluid drive medium and be configured to produce a product fluid outlet pressure which is similar to the drive fluid pressure. At least one pressure modulating device may be configured to produce an outlet product fluid pressure which is dissimilar to the drive fluid pressure, for example an outlet pressure which is greater or less than the drive fluid pressure. This arrangement may permit at least one pressure modulating device to function as a pressure magnifier, which may have a magnification factor less than 1 to produce an outlet pressure which is less than the drive fluid pressure, and/or a magnification factor greater than 1 to produce an outlet pressure which is greater than the drive fluid pressure. In some embodiments the magnification factor of at least one pressure modulating device may be variable, or fixed.

At least one pressure modulating device may comprise a piston assembly configured to be driven by the drive medium. The piston assembly may comprise a drive fluid chamber defining a fluid inlet in communication with the drive fluid, for example supplied via the control device. The piston assembly may comprise a product fluid chamber defining a fluid outlet in communication with the target location. The product fluid chamber may define a fluid inlet in communication with a product fluid source.

The piston assembly may comprise a piston member configured to be displaced relative to said fluid chambers. The piston member may comprise a drive fluid piston area configured to be exposed to the drive fluid within the drive fluid chamber, and a product fluid piston area configured to be exposed to the product fluid within the product fluid chamber. In this arrangement a force applied on the drive fluid piston area by the drive fluid pressure will be transmitted to the product fluid piston area to manifest as pressure within the product fluid. The drive and product fluid piston areas may be substantially similar. The drive and product fluid piston areas may be different. A differential piston area may permit a pressure differential between the drive fluid pressure and the outlet product fluid pressure to be achieved. The ratio between the piston areas may define a pressure differential ratio between the drive fluid and product fluid. The piston area ratio may be selected in accordance with the required application.

The drive fluid pressure may be increased to increase the pressure force applied to the piston assembly. In this arrangement the increasing pressure of the drive fluid may generate a force on the piston member which exceeds the force developed by the product fluid pressure, thus creating a net increase in the product fluid pressure.

The drive fluid pressure may be decreased to reduce the pressure force applied to the piston assembly. In this arrangement the decreasing pressure of the drive fluid may generate a force on the piston member which is less than the force developed by the product fluid pressure, thus creating a net decrease in the product fluid pressure.

The piston assembly may be double acting, such that operation may be achieved in reverse stroking directions. The piston assembly may be single acting. The piston assembly may be configured to stroke in a first direction to increase the pressure of product fluid at the target location, and to stroke in a second direction to decrease the pressure of product fluid at the target location.

The piston assembly may be arranged such that when the piston member strokes in a first direction product fluid pressure at the target location is increased. This may also result in delivery of product fluid to the target location. The piston assembly may be arranged such that when the piston member strokes in a second direction product fluid is drawn into the product fluid chamber, for example from a product fluid source. The product fluid may be drawn into the chamber at a supply pressure.

The piston assembly may comprise first and second product fluid chambers, and the piston member may comprise respective first and second product fluid piston areas. in this arrangement stroking of the piston member in a first direction may cause the first product fluid chamber to receive product fluid and the second product fluid chamber to increase the pressure of the product fluid at the target location. Stroking of the piston member in a second, reverse direction may cause the first product fluid chamber to increase the pressure of the product fluid at the target location and the second product fluid chamber to receive product fluid. Reciprocation of the piston member may therefore permit continuous control of the pressure at the target location.

The piston assembly may comprise first and second drive fluid chambers, and the piston member may comprise respective first and second drive fluid piston areas. The first and second drive fluid piston areas may be configured to be alternately exposed to drive fluid pressure. This may be permitted by use of a directional control valve arrangement. For example, a directional control valve arrangement may be configured to alternate drive fluid supply between the first and second drive fluid chambers once the stroking limit of the piston member has been reached.

At least one pressure modulating device may comprise a non-return arrangement. A non-return valve arrangement may be configured to prevent release of pressure of product fluid from the target location. A non-return valve arrangement may be configured to prevent release of product fluid from a product fluid chamber to a product fluid source. The non-return arrangement may comprise one or more non-return valves.

At least one modulating device may comprise a pressure relief arrangement configured to selectively release pressure from a target location. The pressure relief arrangement may be configured to be operated by the drive fluid. The pressure relief arrangement may be configured to permit flow of product fluid towards a product fluid source. The pressure relief arrangement may comprise a valve arrangement.

in one embodiment the pressure relief arrangement may be configured to be operated by a mechanical force. The pressure relief arrangement may be configured to be operated by a mechanical force provided by a piston assembly. The piston assembly may be defined by a piston assembly of at least one pressure modulating device. For example, a piston member of the piston assembly may be caused to be displaced by a net pressure force differential between the drive fluid and the product fluid. In one embodiment the pressure relief arrangement may be configured to relieve product fluid pressure when the pressure force applied by the product fluid on the piston assembly exceeds the pressure force applied by the drive fluid.

The pressure modulating arrangement may comprise at least two pressure modulating devices. At least two pressure modulating devices may be configured to receive a common drive medium. The at least two pressure modulating devices may be configured to be operated by a drive medium at a common pressure, common electrical output or the like. This arrangement may provide significant advantages in terms of minimising the complexity of the system, for example by eliminating the requirement to provide separate or individually dedicated and controlled sources of drive medium to operate separate pressure modulating devices.

At least two pressure modulating devices may be arranged in parallel. In this arrangement the pressure modulating devices may each be configured to generate the same product fluid pressure. This may provide advantages in terms of redundancy, for example when one pressure modulating device fails or is deactivated.

At least two pressure modulating devices may be arranged in series. In this arrangement a first pressure modulating device may be configured to establish a first product fluid pressure and communicate this to a second pressure modulating device, wherein the second pressure modulating device may be configured to modify the pressure of the received product fluid to establish a second product fluid pressure. This arrangement may therefore permit a staged variation, such as increase or decrease, in product fluid pressure at the target location. The individual staged variation in product fluid pressure may be determined in accordance with a pressure magnification factor of each respective pressure modulating device. For example, if each series arranged pressure modulating device has the same pressure magnification factor then the staged pressure variation will be the same, such that the final product fluid pressure at the target location is provided in even pressure variations by each stage. Alternatively, differences in the pressure magnification factor between each pressure modulation device may establish a proportionally split staged variation in the pressure of the product fluid. The staged variation in product fluid pressure may be determined in accordance with respective piston area ratios of each pressure modulating device.

In one embodiment a pressure modulating device may define first and second product fluid chambers, wherein each chamber is configured to be exposed to a common product fluid pressure provided by an adjacent pressure modulating device. This arrangement may permit a fluid dynamic equilibrium to be achieved, such that a pressure magnification effect may be initiated in two or more series arranged pressure modulating devices by a common drive fluid pressure.

One or more pressure modulating devices may be arranged to permit bypass of product fluid pressure. In this arrangement the failure or otherwise of one pressure modulating device within a series arrangement may permit control of the product fluid pressure at the target location to be maintained. That is, the failure or otherwise of one pressure modulating device may result in a reduction in the product fluid pressure at the target location which will be recognised by the control device to effect an appropriate control or variation of the drive medium to compensate for the lack in pressure contribution from the failed or otherwise pressure modulating device. This arrangement may therefore provide robust redundancy within the pressure control system.

The target location may comprise a single region. In this arrangement the pressure modulating arrangement may be configured to modulate the pressure of the product fluid at this single location. The pressure at the single region may be provided by one or more pressure modulating devices.

The target location may comprise at least two regions. In this arrangement the pressure modulating arrangement may be configured to modulate the pressure of the product fluid at the at least two regions. in one embodiment the pressure modulating arrangement may be configured to modulate the pressure of the product fluid at at least two regions towards the same target pressure. The pressure modulating arrangement may be configured to modulate the pressure of the product fluid at one region towards a first target pressure, and modulate the pressure of the product fluid at another region towards a second target pressure.

in one embodiment the pressure modulating arrangement may comprise at least two pressure modulating devices, wherein one or more pressure modulating devices are configured to modulate the pressure at one region, and one or more other pressure modulating devices are configured to modulate the pressure at another region.

The pressure modulating arrangement may comprise at least two pressure modulating devices arranged in series. At least two series arranged pressure modulating devices may be configured to receive a common drive medium.

A first pressure modulating device or devices may be configured to establish a first product fluid pressure and communicate this to both a first region and a second pressure modulating device or devices, wherein the second pressure modulating device or devices may be configured to modify the pressure of the received product fluid to establish a second product fluid pressure and communicate this to a second region. Where the target location comprises more than two regions, the pressure modulating apparatus may comprise more than two pressure modulating devices. This arrangement may therefore permit a staged variation, such as increase or decrease, in product fluid pressure at the different regions. The individual staged variation in product fluid pressure may be determined in accordance with a pressure magnification factor of each respective pressure modulating device. The staged variation in product fluid pressure may be determined in accordance with respective piston area ratios of each pressure modulating device.

Where the target location comprises multiple regions the control device may be configured to monitor the pressure in one or more of these regions.

The present invention may have numerous applications in permitting the pressure of a product fluid at a target location to be controlled towards a target pressure. Some exemplary applications have been defined below. However, these are not intended to limit the scope of the invention.

The pressure control system may be used in combination with a sealing assembly configured to seal a pressurised region. The sealing assembly may comprise at least one sealing chamber configured to receive a sealing fluid at a desired pressure. Accordingly, the pressure control system according to the present invention may be configured for use in modulating the pressure of a sealing fluid within the at least one sealing chamber towards a target pressure. In this arrangement the control device may be configured to monitor the pressure within the pressurised region, and control the drive medium according to this monitored pressure to permit the pressure modulating arrangement to modulate the pressure of the sealing fluid towards a target pressure. In one embodiment the target pressure may be substantially similar to the pressure within the pressurised region. The target pressure may be configured to be consistently elevated above or below the pressure within the pressurised region, for example by applying a biasing pressure within the system. This arrangement may permit a preferential leakage of sealing fluid into or out of the pressurised region. The sealing fluid may comprise a lubricant.

The sealing assembly may comprise a plurality of sealing chambers, wherein the pressure control system is adapted to modulate the pressure within each sealing chamber towards a target pressure. The pressure control system may be configured to modulate the pressure within two or more sealing chambers towards a substantially similar target pressure. The pressure control system may be configured to modulate the pressure within two or more sealing chambers towards different target pressures. In one arrangement the pressure control system may be configured to generate a staged pressure difference between two or more sealing chambers. This arrangement may permit the sealing assembly to appropriately manage sealing of a pressure differential by distributing the pressure differential proportionally between different sealing chambers.

The sealing assembly may define a static seal.

The sealing assembly may define a dynamic seal. For example, the sealing assembly may define a seal between stationary and moving components, such as rotational components, rectilinearly displaced components.

The sealing assembly may be configured to provide a seal against an elongate body being displaced relative to a stationary component. For example, the sealing assembly may be configured to provide a seal against a spoolable elongate member, such as wireline, coiled tubing or the like into a pressurised region, such as a wellbore. The sealing assembly may be configured for use in a stuffing box, lubricator or the like.

The sealing assembly may be configured to provide a seal against a rotating shaft, such as a rotating shaft of a pump or, the like.

In one embodiment the sealing assembly may be configured for use in a drive assembly of a bore drilling platform. The drive assembly may comprise a top drive assembly, rotary table and kelly assembly or the like. For example, the sealing assembly may be configured to provide a seal against a drive shaft which may contain a pressurised fluid, such as drilling mud.

The pressure control system may be used in fluid injection applications, such as injection of fluid into a subterranean formation. Injection applications may include water injection, formation fracturing or the like. The pressure control system may be configured to modulate the injection pressure of an injection fluid, such as water, fracturing fluid, proppant or the like, at one or more injection zones within a wellbore. For example, it may be desirable to provide an injection pressure which differs between different injection zones, for example due to differences in formation geology and the like.

The pressure control system may be configured for use as a pressure relief system, for example for use in relieving pressure from a pressurised regions, such as within a pressure vessel.

Other applications may include use in actuation of a tool, use in absorbing energy, for example in a damping assembly, sealing different areas with similar or different pressures from a single drive source.

According to a second aspect of the present invention there is provided a method of controlling the pressure of a product fluid at a target location, comprising:

communicating a pressure modulating arrangement with a target location;

monitoring at least one reference pressure and controlling a drive medium being delivered to the pressure modulating arrangement in accordance with said monitored reference pressure to permit the pressure modulating arrangement to modulate the pressure of the product fluid towards a target pressure.

The method according to the second aspect may be carried out by the pressure control system according to the first aspect. All features and methods of use of the pressure control system defined above, singly or in combination, may be applicable to the method of the second aspect.

According to a third aspect of the present invention there is provided a pressure control system comprising:

at least two pressure modulating devices adapted to be operated by a common drive medium to modulate the pressure of a product fluid at a target location towards a target pressure; and

a control device configured to monitor at least one reference pressure and to control the drive medium being delivered to at least two pressure modulating devices in accordance with said at least one reference pressure.

The target location may comprise a single region.

The target location may comprise at least two regions, wherein the at least two pressure modulating devices are configured to modulate the pressure of a product fluid at the at least two regions.

Different regions may have a substantially similar target pressure. Different regions may have different target pressures.

Features defined in accordance with the first aspect may be applicable to the third aspect.

According to a fourth aspect of the present invention there is provided a pressure control system comprising:

a control device configured to monitor a reference pressure;

a drive medium configured to be controlled by the control device in accordance with the monitored reference pressure;

a first pressure modulating device configured to be operated by the drive medium to generate a first pressure within a product fluid; and

a second pressure modulating device configured to be operated by the drive medium to generate a second pressure within a product fluid.

The first and second pressure modulating devices may be configured to be operated by a commonly controlled drive medium. For example, the first and second pressure modulating devices may be configured to be operated by a drive medium having a common fluid pressure, electrical output or the like.

The first and second pressure modulating devices may be configured to communicate with one or more target location. In this arrangement the first and second pressure modulating devices may be configured to modulate the pressure at the target location, for example towards a target pressure. The first and second pressure modulating devices may be configured to communicate with the same target location, or different target locations.

in one arrangement the first pressure modulating device may be configured to communicate with a first target region, and the second pressure modulating device may be configured to communicate with a second target region.

The first pressure modulating device may be configured to communicate pressure to the second modulating device.

The first pressure may be substantially equivalent to the second pressure.

The first pressure may be different from the second pressure.

Features defined above in relation to the first aspect may apply to the fourth aspect.

According to a fifth aspect of the present invention there is provided a product fluid delivery system comprising:

a product fluid delivery arrangement adapted to be operated by a drive medium to deliver a product fluid to or from a target location; and

a control device configured to monitor at least one reference pressure and to control the drive medium being delivered to the pressure modulating arrangement in accordance with said at least one reference pressure.

Features defined above in relation to the first aspect may apply to the fifth aspect. For example, the pressure modulating arrangement defined in accordance with the first aspect may be equivalent to the product fluid delivery arrangement defined in accordance with the fifth aspect.

According to a sixth aspect of the present invention there is provided a control system for a sealing assembly having a seal chamber, said control system comprising:

a pressure modulating arrangement adapted to be operated by a drive medium to modulate the pressure of a sealing fluid within a seal chamber of a sealing assembly towards a target pressure; and

a control device configured to monitor at least one reference pressure and to control the drive medium being delivered to the pressure modulating arrangement in accordance with said at least one reference pressure.

The sealing assembly may be used to contain pressure within a pressurised region. in this arrangement the control device may be configured to monitor a pressure within the pressurised region to permit the pressure of the sealing fluid to be modulated accordingly.

The sealing assembly may comprise a plurality of sealing chambers, wherein the control system is configured to modulate the pressure within two or more of the sealing chambers.

Features defined above in relation to the first aspect may apply to the sixth aspect.

According to a seventh aspect of the present invention there is provided a sealing apparatus comprising:

a sealing assembly comprising a sealing chamber;

a pressure modulating arrangement adapted to be operated by a drive medium to modulate the pressure of a sealing fluid within the seal chamber towards a target pressure; and

a control device configured to monitor at least one reference pressure and to control the drive medium being delivered to the pressure modulating arrangement in accordance with said at least one reference pressure.

The sealing assembly may be used to contain pressure within a pressurised region. In this arrangement the control device may be configured to monitor a pressure within the pressurised region to permit the pressure of the sealing fluid to be modulated accordingly.

The sealing assembly may comprise a plurality of sealing chambers, wherein the control system is configured to modulate the pressure within two or more of the sealing chambers.

Features defined above in relation to the first aspect may apply to the seventh aspect.

According to an eighth aspect of the present invention there is provided a drive assembly comprising a control system according to the sixth aspect or a sealing assembly according to the seventh aspect.

The drive assembly may comprise a top drive assembly. The drive assembly may comprise a rotary table drive assembly.

According to a ninth aspect of the present invention there is provided an apparatus configured to control a variable flow device, comprising:

a piston member defining a first piston area configured to be exposed to a pressure from a first location to impart a first force on the piston member, and a second piston area configured to be exposed to a pressure at a second location to impart a second force on the piston member,

wherein the piston member is moved in a direction according the first and second forces to provide a mechanical output to a variable flow device.

The variable flow device may be configured to vary the flow of a medium, such as a fluid, electric output or the like. The variable flow device may be configured to vary a property of a medium, such as the pressure of a fluid.

The apparatus may be configured to generate a preferred bias force on the piston member.

Aspects of the present invention may relate to a fluid control system configured to supply a product fluid to one or more target locations. Such aspects may share similar features defined in relating to the previous aspects. For example, aspects defined to modulate the pressure at a target location may be considered equivalent to aspects to modulate the fluid supply to a target location. All associated features may therefore be construed accordingly.

### BRIEF DESCRIPTION OF THE DRAWINGS

These and other aspect of the present invention will now be described, by way of example only, with reference to the accompanying drawings, in which:

FIG. 1 is a diagrammatic representation of a generic exemplary embodiment of one or more aspects of the present invention;

FIGS. 2 to 9 are diagrammatic representations of a pressure control system in accordance with various alternative embodiments of the present invention; and

FIG. 10 is a diagrammatic representation of an exemplary application of a pressure control device according to an embodiment of the present invention.

### DETAILED DESCRIPTION OF THE DRAWINGS

It should be understood that the present invention may be embodied in a large number of manners, and while a number of exemplary embodiments have been presented herein it should be understood that these are not limiting. Instead, the scope of the present invention is defined by the appended claims.

Where the terms “up” or “upwards”, or “down” or “downwards” are used these are intended to describe movement or positioning of components with respect to the drawings and do not suggest nor limit the actual orientation of the element when in use.

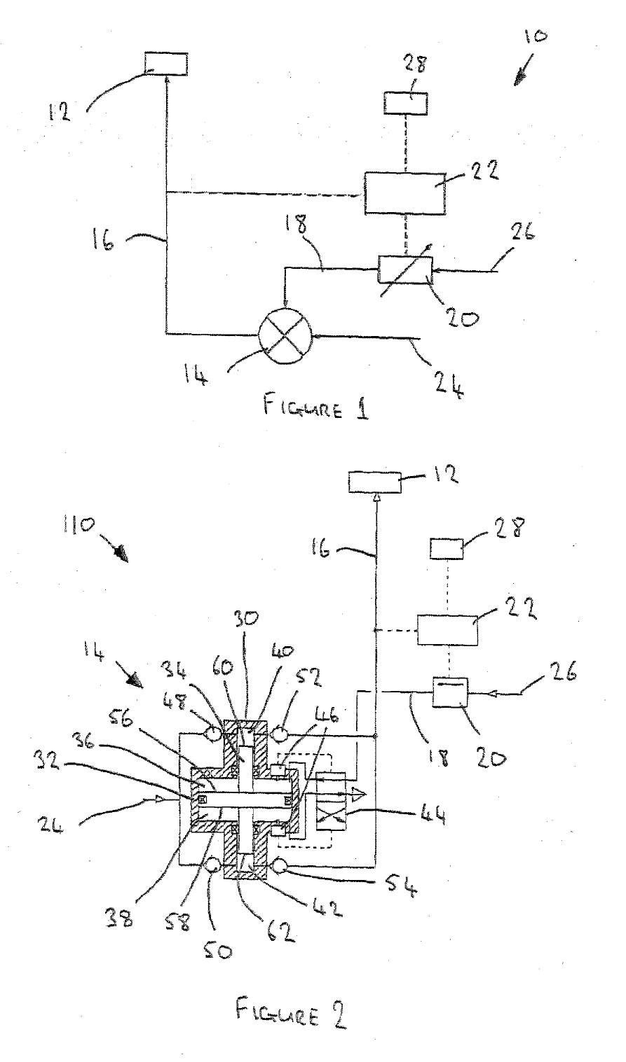

Referring to FIG. 1, there is shown a pressure control system in accordance with an exemplary embodiment of the present invention. The pressure control system, generally identified by reference numeral 10, is configured for use in modulating the pressure of a product fluid at a target location 12 towards a target pressure.

The system 10 comprises a pressure modulating arrangement 14 which is in communication with the target location 12 via a conduit 16 and is configured to modulate the pressure of a product fluid at the target location 12. The pressure modulating arrangement 14 is operated by a drive medium supplied via conduit 18 from a variable controller 20 which is controlled by a control device 22, such that variations in the supply of the drive medium permits modulation of the pressure at the target location 12 to be achieved. The pressure modulating arrangement 14 is in communication with a product fluid source via conduit 24, and the variable controller 20 is in communication with a drive medium source via conduit 26.

The pressure modulating arrangement 14 may be configured to be operated by a fluid, electrical output or the like. Accordingly, depending on the type of pressure modulating arrangement 14 selected for use in the system 10, the drive medium may comprise a fluid, electrical output or the like. Variations in the drive medium may therefore include variations in flow rate, pressure, electrical output, electrical power or the like.

In the embodiment shown the target pressure at the target location 12 is associated with a reference pressure. For example, the target pressure may be selected to be slightly elevated above a reference pressure. The control device 20 is configured to monitor the reference pressure and control the variable controller 20 accordingly to permit the pressure modulating arrangement 14 to modulate the pressure at the target location 12 towards the target pressure. The monitored reference pressure may be a pressure stored on the control device 22. In the embodiment shown, however, the control device 22 is configured to monitor a reference pressure at a reference location 28.

The control device 22 is configured to monitor the pressure at the target location 12 and track this monitored target location pressure relative to the reference pressure at the reference location 28. Such tracking of pressures will permit the control device 22 to control the variable controller 20 and thus the drive medium in order to modulate the pressure at the target location towards the target pressure.

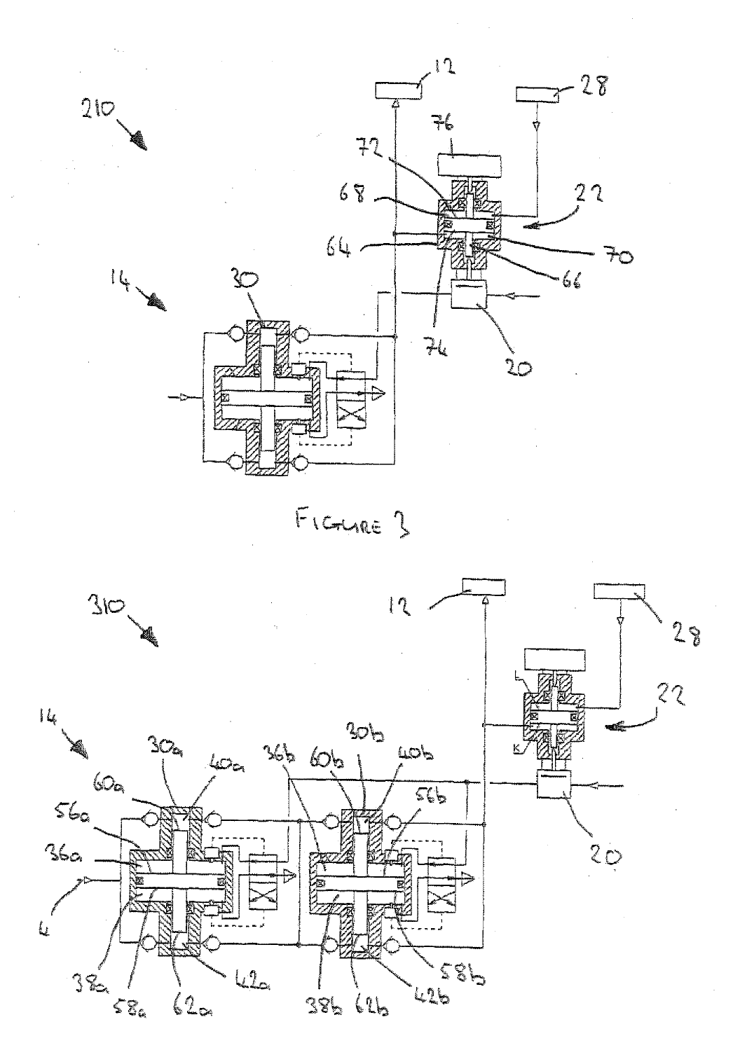

It should be noted that FIG. 1 generically presents an embodiment of one or more aspects of the present invention. Each feature presented in FIG. 1, such as the pressure modulating arrangement 14 and control device 22 may be provided in a number of different ways and configurations. Some examples of such alternative configurations of various features of the system shown in FIG. 1 are presented below with reference to FIGS. 2 to 9.

Reference is first made to FIG. 2 in which there is shown a pressure control system, generally identified by reference numeral 110, in accordance with an embodiment of the present invention. The general arrangement of the system 110 of FIG. 2 is similar to that of FIG. 1 and as such similar reference numerals for similar features have been used. Accordingly, the system 110 includes a pressure modulating arrangement 14, a variable controller 20 and a control device 22 and is arranged to modulate the pressure of a product fluid at a target location 12 towards a target pressure. The target pressure is associated with a reference pressure and the controller 22 is configured to monitor the pressure at a target location 12 and the pressure at a reference location 28 and control the drive medium accordingly via the variable controller 20.

In the embodiment shown in FIG. 2 the pressure modulating arrangement 14 is operated by a fluid drive medium, such as air, and comprises a single pressure modulating device in the form of a pump 30. The pump 30 comprises a cylinder body 32 within which a piston member 34 is moveably mounted to stroke in reverse directions. The cylinder body 32 and piston member 34 collectively define first and second drive fluid chambers 36, 38 and first and second product fluid chambers 40, 42.

Each drive fluid chamber 36, 38 is configured to alternately receive drive fluid from the variable controller 20 via conduit 18 in accordance with a directional control valve 44. The directional control valve 44 is adapted to alternate the supply of drive fluid between the drive fluid chambers 36, 38 by use of limit control switches 46. The directional control valve 44 in FIG. 2 is shown configured to permit drive fluid flow into the first drive fluid chamber 36.

Each product fluid chamber 40, 42 is in fluid communication with a product fluid source via conduit 24 and respective check valves 48, 50. The check valves 48, 50 are configured to permit flow of product fluid only in the direction into the respective chambers 40, 42. Each product fluid chamber 40, 42 is also in fluid communication with the target location 12 via conduit 16 and respective check valves 52, 54. The check valves 52, 54 are configured to permit flow of product fluid only in the direction out of the respective chambers 40, 42.

The piston member 34 defines a first drive fluid piston area 56 and a second drive fluid piston area 58 configured to be exposed to drive fluid pressure within the respective drive fluid chambers 36, 38. Similarly, the piston member 34 defines a first product fluid piston area 60 and a second product fluid piston area 62 configured to be exposed to product fluid pressure within the respective product fluid chambers 40, 42.

In use, drive fluid pressure within the first drive fluid chamber 36 will act against the first drive fluid piston area 56 to generate a downward force on the piston member 34. If the downward force is sufficient to move the piston member 34 in a downward direction this will cause the first product fluid chamber 40 to expand in volume and will permit product fluid to be drawn into chamber 40 via check valve 48, while check valve 52 prevents back flow of product fluid from the target location 12. At the same time the second product fluid chamber 42 will contract in volume causing drive fluid contained therein to flow towards the target location 12 through check valve 54, while check valve 50 will prevent return flow of the product fluid to the product fluid source via conduit 24. If the target location 12 represents a closed or partially closed region then this will result in a pressure increase at the target location 12. The pressure developed in the product fluid will be proportional to the pressure of the drive fluid and the ratio of the first drive fluid and second product fluid piston areas 56, 58. In the embodiment shown the first drive fluid piston area 56 is larger than the second product fluid piston area 62, such that the pressure generated in the product fluid will be greater than the pressure of the drive fluid.

When the piston member 34 reaches its stoke limit the limit switches 46 and directional control valve 44 will permit the supply of drive fluid to be diverted to the second drive fluid chamber 38 and the process may then be repeated to permit continuous operation.

Continued monitoring of the pressures at the target location 12 and the reference location 28 will permit the control device 22 to control the drive fluid being delivered to the pump 30 to permit the pump 30 to modulate the pressure being communicated to the target region 12. in this way the system 110 may continuously seek to achieve the target pressure at the target location 12, while accounting for, for example, variations in pressure at the reference location 28. Specifically, in the embodiment shown, when the pressure at the target location 12 falls below the pressure at the reference location 28 the control device 22 controls the variable controller 20 to increase the pressure of the drive fluid to thus increase the pressure of the product fluid at the target location. Conversely, if the pressure at the target location 12 exceeds the pressure at the reference location 28, the control device 22 may control the variable controller 22 to reduce the drive fluid pressure.

The control device 22 in FIGS. 1 and 2 may be provided by any suitable device, such as a mechanical device, electrical device or the like. An exemplary embodiment of a suitable control device according to the present invention is shown in FIG. 3, reference to which is now made.

FIG. 3 shows a pressure control system, generally identified by reference numeral 210, in accordance with an embodiment of the present invention. The system 210 comprises a pressure modulating arrangement 14 which includes a pump 30. The pump 30 is identical to that shown in FIG. 2 and as such no further description shall be given.

The system 210 further comprises a control device 22 which is formed by a mechanical arrangement, specifically a fluid piston assembly. The control device piston assembly 22 comprises a cylinder body 64 and a piston member 66 arranged to move within the cylinder body 64. The piston member 66 is arranged to engage the variable controller such that moving of the piston member 66 will effect control of the variable controller 20.

The piston member 66 and cylinder body 64 collectively define first and second chambers 68, 70, wherein the first chamber 68 is in communication with the reference location 28 and the second chamber 70 is in communication with the target location 12.

The piston member 66 defines a first piston area 72 configured to be exposed to the reference pressure from the reference location 28. The piston member 34 also defines a second piston area 74 configured to be exposed to product fluid pressure at the target location 12. In use, reference pressure within the first chamber 68 will act against the first piston area 72 to generate a downward force on the piston member 66, and product fluid pressure within the second chamber 70 will act against the second piston area 72 to generate an upward force on the piston member 66. Any differential between the forces applied on the piston areas 72, 74 will cause the piston member 66 to move accordingly, and thus control the variable controller 20. When the forces applied on the piston member 66 reach equilibrium no net movement is achieved and in this event the pressure at the target location will be considered to have reached the target pressure. Any variation in pressure at the target location 12 or reference location 28 to upset this equilibrium position will be accommodated by the control device piston assembly 22, such that force equilibrium will be automatically and continuously tracked.

The control device piston assembly 22 is configured to apply a bias to the piston member 66. In the embodiment shown the control device piston assembly 22 comprises a biasing arrangement 76 which imparts an additional force to the piston member 66, such that the downward force on the piston member 66 will be a combination of the bias force and the reference pressure force. In this arrangement the target pressure at the target location 12 will be consistently larger than the reference pressure by virtue of the biasing arrangement.

Although not illustrated in FIG. 3, bias may alternatively, or additionally be applied to the piston member 66 by use of differential piston areas 72, 74.

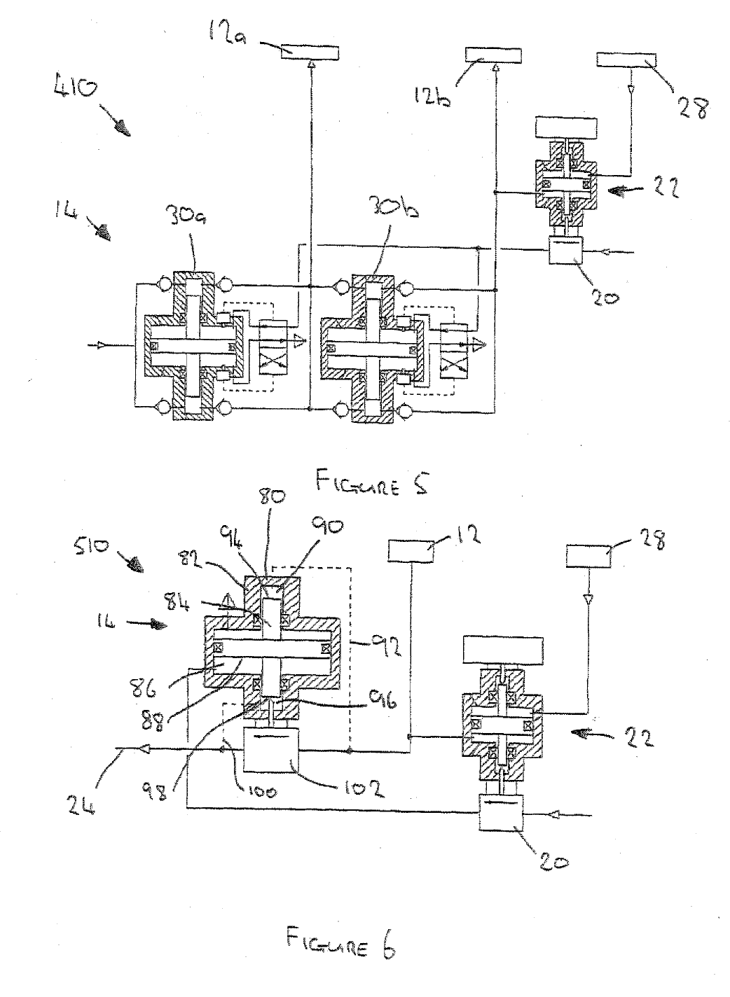

Reference is now made to FIG. 4 which diagrammatically shows a pressure control system, generally identified by reference numeral 310, in accordance with an alternative embodiment of the present invention. The general arrangement of the system 310 of FIG. 4 is similar to that of FIG. 1 and as such similar reference numerals for similar features have been used. Accordingly, the system 310 includes a pressure modulating arrangement 14, a variable controller 20 and a control device 22 and is arranged to modulate the pressure of a product fluid at a target location 12 towards a target pressure. The control device 22 is provided in the form of a piston assembly similar to that shown in FIG. 3 and as such no further specific description will be provided. However, it should be noted that in other embodiments an alternative control device may be used, such as an electronic control device.

The pressure modulating arrangement 14 comprises two pressure modulating devices in the form of first and second pumps 30a, 30b. Pumps 30a, 30b are similar to pump 30 shown in FIG. 2 and as such like features share like reference numerals, followed by the letter ‘a’ for first pump 30a, and ‘ID’ for second pump 30b. For brevity no further specific description of the pumps 30a, 30b will be provided.

The pumps 30a, 30b are arranged in series such that product fluid from the product fluid chambers 40a, 42a of the first pump 30a is communicated to the product fluid chambers 40b, 42b of the second pump 30b, and product fluid from chambers 40b, 42b of the second pump 30b is communicated to the target location 12. Furthermore, the pumps 30a, 30b are configured to receive a common drive fluid from the variable controller 20, such that each active drive fluid chamber of each pump 30a, 30b is exposed to a common drive pressure.

In use, the first pump 30a will establish a pressure within the product fluid which is proportional to the drive fluid pressure and the respective piston area ratios between piston areas 56a, 62a, and piston areas 58a, 60a. As this product fluid pressure is supplied to both product fluid chambers 40b, 42b of the second pump 30b, application of the common drive fluid pressure will cause a further increase in the product fluid pressure. This further increase will be proportional to the drive fluid pressure and the respective piston area ratios between piston areas 56b, 62b, and piston areas 58b, 60b.

Accordingly, in normal use both pumps 30a, 30b will contribute to the final product fluid pressure supplied to the target location 12. The proportion of the final product fluid pressure being contributed by each pump 30a, 30b will be a function of the piston ratios within each pump 30a, 30b. For example, in the embodiment shown the piston ratios are equivalent such that half of the final product fluid pressure is provided by the first pump 30a, and half is provided by the second pump 30b.

In a similar manner to that described above, the control device piston assembly 22 tracks the pressure at the target location 12 and the pressure at the reference location and modifies the drive pressure accordingly.

As noted above, when both pumps 30a, 30b are operational the product fluid pressure at the target location 12 is established by both pumps 30a, 30b. However, in the event of one pump becoming inoperative, for example due to failure, an initial reduction in pressure at the target location 12 will occur which will be recognised by the control device piston assembly 22. The control device piston assembly 22 will effect an increase in the drive fluid pressure to permit the remaining operational pump to provide the required product fluid pressure. This arrangement may therefore permit an advantageous degree of redundancy to be provided by the system 310.

It should be noted that while the system 310 of FIG. 4 includes two pumps 30a, 30b, the pressure control system of the present invention may include any number of pumps, for example three or more.

Furthermore, the system 310 of FIG. 4 is arranged such that product fluid pressure is modulated by the pressure modulating arrangement 14 at a single target location 12. However, in other embodiments the system may be arranged to modulate the pressure at multiple locations. Such a system is shown in FIG. 5, reference to which is now made. The system, which is generally identified by reference numeral 410, is substantially identical to the system 310 of FIG. 4, with the exception that product fluid pressure from the first pump 30a, in addition to being supplied to the second pump 30b, is delivered to a first target region 12a, and product fluid pressure from the second pump 30b is delivered to a second target region. The pressure at the first target region 12a will be proportional to the pressure of the drive fluid and the piston area ratio of the first pump 30a. The pressure at the second target region 12b will be the sum of the pressure from the first pump 30a and the pressure contribution from the second pump 30b, which will be proportional to the drive fluid pressure and the piston area ratio of the second pump 30b. Accordingly, the pressures at the target locations 12a, 12b will be different, wherein the proportional variation between the different pressures will be a function of the respective piston area ratios within the respective pumps 30a, 30b.

It should be noted that in the event of one pump becoming inoperative, for example due to failure, the other pump may compensate and continue to provide pressure to one or both target locations 12a, 12b.

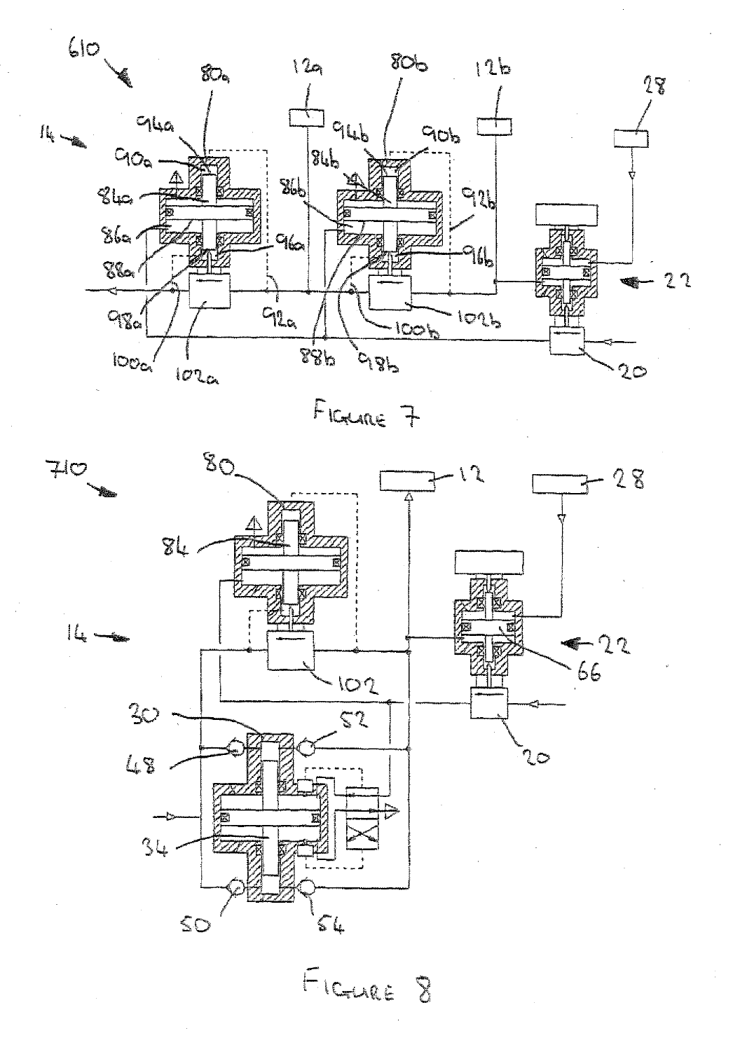

Reference is now made to FIG. 6 in which there is shown a pressure control system, generally identified by reference numeral 510, in accordance with an alternative embodiment of the present invention. The general arrangement of the system 510 of FIG. 6 is similar to that of FIG. 1 and as such similar reference numerals for similar features have been used. Accordingly, the system 510 includes a pressure modulating arrangement 14, a variable controller 20 and a control device 22 and is arranged to modulate the pressure of a product fluid at a target location 12 towards a target pressure. The control device 22 is provided in the form of a piston assembly similar to that shown in FIG. 3 and as such no further specific description will be provided. However, it should be noted that in other embodiments an alternative control device may be used, such as an electronic control device.

The pressure modulating arrangement 14 includes a single pressure modulating device in the form of a compensator 80 which defines a piston assembly having a piston body 82 and a piston member 84. As will be discussed in detail below, the compensator 80 is configured to relieve pressure from the target location 12 towards a product fluid source through conduit 24.

The piston body 82 and member 84 collectively define a drive fluid chamber 86 configured to receive drive fluid from the variable controller 20. The piston member defines a drive fluid piston area 88 which is configured to be exposed to drive fluid to generate a force on the piston member 84 in an upward direction. The piston body 82 and member 84 also collectively define a first product fluid chamber 90 which is configured to receive drive fluid via conduit 92 at the target location pressure, wherein the piston member 84 defines a first product fluid piston area 94 configured to be exposed to product fluid to generate a force on the piston member 84 in a downward direction. The piston body 82 and member 84 further also collectively define a second product fluid chamber 96 which is configured to receive drive fluid via conduit 100 at the product fluid source pressure, wherein the piston member 84 defines a first product fluid piston area 94 configured to be exposed to product fluid to generate a force on the piston member 84 in a downward direction. In other embodiments, however, the second product fluid chamber 96 may not be required.

Accordingly, the piston member 84 will be urged upward by the forces applied by the drive fluid pressure and the product fluid at the source pressure, and will be urged downward by the force applied by the product fluid at the target location pressure. The piston member 84 will be caused to move within the piston body 82 when the upward and downward forces are imbalanced.

The compensator 80 also comprises a product fluid relief valve 102 which is configured to selectively and variably permit release of pressure from the target location 12 towards the product fluid source, and is configured to be operated by movement of the piston member 84.

In use, when the pressure at the reference location 28 is equal to or exceeds the pressure at the target location 12 the control device 22 will control the variable controller 20 to supply product fluid to chamber 86 to urge the piston member 84 upward against the force established by the product fluid. Accordingly, the relief valve 102 will remain closed to maintain the pressure at the target location 12. In some embodiments the piston member 84, when urged upwards, may function to increase the pressure at the target location 12.

Conversely, when the pressure at the target location 12 exceeds the pressure at the reference location, and thus becomes too high relative to a target pressure, the control device 22 will control the variable controller 20 to reduce the pressure of the drive fluid being supplied to chamber 86, thus permitting the piston member 84 to move downwardly and control the relief valve 102 to relieve pressure from the target location. Pressure will continue to be relieved until the pressure at the target location 12 reaches a target pressure, with the control system 510 automatically and continuously adjusting to accommodate changing conditions at the target and reference locations 12, 28.

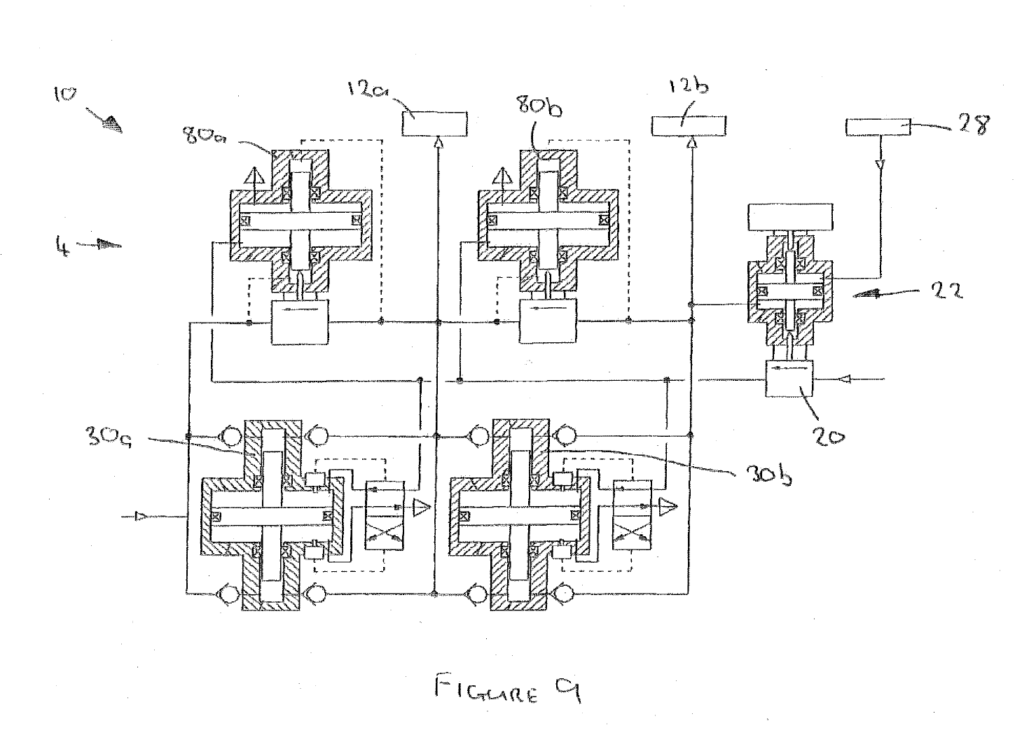

The pressure control system 510 of FIG. 6 is configured to relieve pressure from a single target location. However, in other embodiments arrangements may be provided to permit relief of pressure from a number of locations. Such an exemplary arrangement is shown in FIG. 7, reference to which is now made.

The pressure control system of FIG. 7, which is generally identified by reference numeral 610, is generally arranged in a similar manner to that of FIG. 1 and as such similar reference numerals for similar features have been used. Accordingly, the system 610 includes a pressure modulating arrangement 14, a variable controller 20 and a control device 22 and is arranged to modulate the pressure of a product fluid at a target location 12 towards a target pressure. The control device 22 is provided in the form of a piston assembly similar to that shown in FIG. 3 and as such no further specific description will be provided. However, it should be noted that in other embodiments an alternative control device may be used, such as an electronic control device.

The pressure modulating arrangement 14 comprises two pressure modulating devices in the form of first and second compensators 80a, 80b, which are similar to compensator 80 shown in FIG. 6 and as such like features share like reference numerals, followed by the letter ‘a’ for first compensator 80a, and ‘b’ for second compensator 80b. For brevity no further specific description of the compensators 80a, 89b will be provided.

In the present arrangement the first compensator 80a is configured to relieve pressure from a first target location 12a, and the second compensator 80b is configured to relieve pressure from a second target location, as will be discussed below.

The first product fluid chamber 90a of the first compensator 80a is exposed to fluid pressure at the first target location 12a via conduit 92a, and the drive fluid chamber 86a is exposed to a common drive fluid pressure from the control device 22. When the pressure forces exerted on the piston member 84a are such that the piston member 84a moves downward, the relief valve 102a will be opened to therefore relieve pressure from the first target location 12a.

The first product fluid chamber 90b of the second compensator 80b is exposed to fluid pressure at the second target location 12b via conduit 92b, and the second product fluid chamber 96b is exposed to fluid pressure at the first target location 12a via conduit 100b. Accordingly, any pressure differential between the first and second target locations 12a, 12b will establish a force imbalance on the piston member 84b. The drive fluid chamber 86b of the second compensator 80b is exposed to the common drive fluid pressure from the control device 22, and accordingly when the pressure forces established by the drive fluid pressure and the pressures at the respective target locations 12a, 12b are such to cause the piston member to move downwardly, the relief valve 102b will be opened to relieve pressure from the second target location 12b.

It will be understood that the pressure control arrangement 14 of the system 610 of FIG. 7 will permit pressure relief while maintaining a constant proportional variation between the pressures at the target locations 12a, 12b. This proportional variation will be a function of the respective piston areas within the compensators 80a, 80b.

In a similar manner to that described above, the control device piston assembly 22 tracks the pressure at the reference location 28 and the pressure at the target location 12, specifically target location 12b, and modifies the drive pressure accordingly. Thus, the compensators 80a, 80b will continuously adjust to relieve pressure in accordance with the pressure of drive fluid being supplied, which is controlled by the control device 22.

In the embodiments described above, pump 30 (for example from FIG. 2) is configured to increase pressure at a target location, and compensator 80 (for example from FIG. 6) is configured to relieve pressure from a target location. A further exemplary embodiment of the present invention may be arranged to incorporate both at least one pump 30 and at least one compensator 80 to provide complete pressure control at a target location. Such an embodiment of a pressure control system, generally identified by reference numeral 710, is shown in FIG. 8, reference to which is now made.

The pressure control system 710 of FIG. 8 is generally configured in the same manner as the system of FIG. 1, and as such includes a pressure modulating arrangement 14, a variable controller 20 and a control device 22 and is arranged to modulate the pressure of a product fluid at a target location 12 towards a target pressure. The control device 22 is provided in the form of a piston assembly similar to that shown in FIG. 3 and as such no further specific description will be provided. However, it should be noted that in other embodiments an alternative control device may be used, such as an electronic control device.

The pressure modulating arrangement 14, as suggested above, includes a pump 30 and a compensator 80, which have previously been described, wherein the pump 30 and compensator 80 are configured to receive a common drive fluid pressure from the control device 22.

In use, when the pressure at the target location 12 falls below a target pressure, which is associated with the pressure at the reference location 28, the piston member 66 of the control device piston assembly 22 will be caused to move downwardly to control the variable controller 20 to increase the drive fluid pressure supplied to both the pump 30 and compensator 80. This increase in drive pressure will cause the piston member 34 of the pump 30 to stroke to effect an increase in the pressure of product fluid at the target location 12. Similarly, the increase in drive fluid pressure will prevent the piston member 84 of the compensator 80 from moving downward and thus will maintain the relief valve 102 in a closed position.

Conversely, when the pressure at the target location 12 exceeds a target pressure, for example caused by a decrease the pressure at the reference location 28, the piston member 66 of the control device piston assembly 22 will be caused to move upwardly to control the variable controller 20 to decrease the drive fluid pressure supplied to both the pump 30 and compensator 80. This increase in drive pressure will cause the piston member 84 of the compensator 80 to move downward and thus control the relief valve 102 to permit pressure to be relieved from the target location 12.

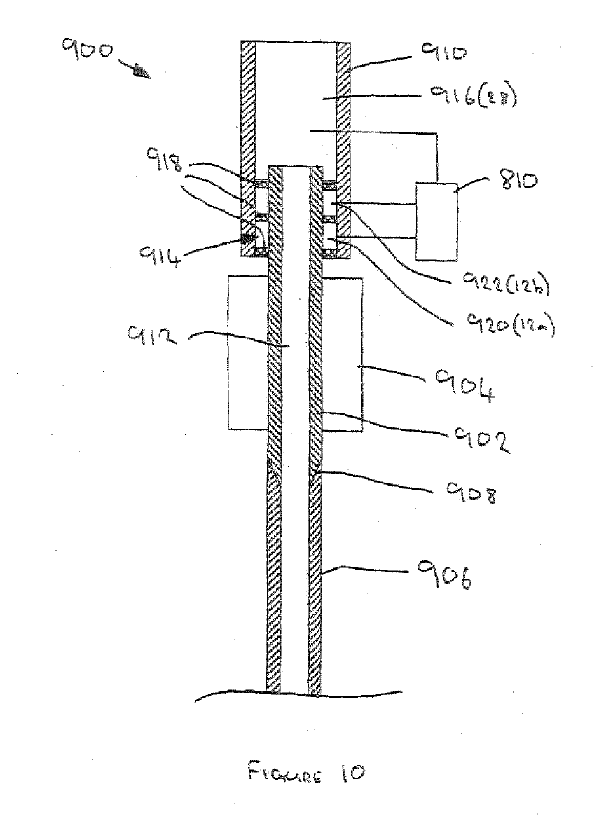

It will be appreciated that a control device according to the present invention may be provided which has any required number of pumps and compensators, and may be used to modulate the pressure at one or more target locations. For example, a control device, generally identified by reference numeral 810 is shown in FIG. 9 which includes two pumps 30a, 30b and two compensators 80a, 80b, and is configured to modulate the pressure at two target locations 12a, 12b relative to a reference pressure at a reference location 28. The combination and functionality of pumps 30a, 30b is similar to that described above with reference to FIG. 5 and as such no further specific description will be provided. Additionally, the combination of compensators 80a, 80b is similar to that described above with reference to FIG. 7 and as such no further specific description will be provided.

However, it is to be noted that in the arrangement shown in FIG. 9 all pumps 30a, 30b and compensators 80a, 80b are operated by a common drive fluid pressure supply, and are collectively arranged to permit respective pressures to be maintained at the target locations 12a, 12b which proportionally vary relative to each other in accordance with the appropriate piston area ratios. For example, if the piston area ratios in both pumps 30a, 30b are equal, then this will result in the pressure within the first target location 12a to be continuously controlled to be half of the pressure within the second target location. Accordingly, varying the relative piston area ratios between pumps 30a, 30b (and also between compensators 80a, 80b) will permit control of the proportional variation in pressure between locations 12a, 12b. It should be noted that this same principle will apply to systems having more than two pumps or compensators.

It will be appreciated by those of skill in the art that the present invention may have numerous applications where the pressure at one or more target locations must be modulated. However, an exemplary application of the present invention is demonstrated in FIG. 10, reference to which is now made.

FIG. 10 is a diagrammatic representation of a top drive assembly, generally identified by reference numeral 900. Top drive assemblies are well known and are used in the creation of subterranean drilled bores, such as wellbores in the oil and gas industry. Specifically, top drives are used to impart rotation to an upper end of a drill string which supports a drill bit at the lower end thereof to drill into the earth. Drilling is normally performed while supplying a drilling fluid, generally referred to as drilling mud, through the drill string to exit into the drilled bore at the location of the drill bit to lubricate the drill bit and assist removal of drill cuttings. The drilling mud is typically delivered at high pressure which generates the requirement to establish sealing within the top drive assembly to prevent leakage of the drilling mud between rotating and stationary components. Embodiments of the present invention may therefore be used in establishing such sealing, as discussed below.

The top drive assembly 900 includes a drive shaft 902 and a motor 904 which is configured to rotate the drive shaft. The drive shaft 902 is arranged to be connected to the upper end of a drill string 906 via a threaded connector 908 to permit the drill string 906 to be rotated by the drive shaft 902. The top drive 900 further comprises a drilling mud supply pipe 910 which is arranged to deliver drilling mud into a central bore 912 of the drive shaft 902 and drill string 906. A dynamic sealing assembly 914 is interposed between the rotating drive shaft 902 and the stationary supply pipe 910 to prevent leakage of mud from region 916. The sealing assembly 914 is configured to accommodate a pressure differential created between mud pressure within region 916 and ambient pressure externally of the top drive 900.

The sealing assembly 914 comprises three seal barriers 918 which define respective sealing chambers 920, 922 therebetween. Each sealing chamber 920, 922 is configured to receive a sealing fluid at a desired pressure to establish a robust seal to accommodate the required pressure differential. Specifically, each seal chamber 920, 922 receives a sealing fluid at a different pressure such that the entire pressure differential is accommodated in a cascading staged manner across the entire seal assembly 914. Specifically, the pressure of sealing fluid within chamber 922 will be greater than the pressure of sealing fluid within sealing chamber 920. That is, the pressure reduction across the seal assembly 914 is in the same direction as the pressure differential being contained.

It is important to ensure that the pressure of the sealing fluid within the respective chambers 920, 922 is appropriately controlled to accommodate for variations in mud pressure and leakage or loss of the sealing fluid. Such control may be provided by a pressure control system according to an embodiment of the present invention. For example, pressure control system 810 shown in FIG. 9 may be used to modulate the sealing fluid pressures. In this arrangement sealing chamber 920 may define a first target location 12a, and sealing chamber 922 may define a second target location 12b represented in FIG. 9. Furthermore, region 916 within the top drive 900 may define a reference location 28 represented in FIG. 9. Accordingly, the system 810 will continuously monitor the reference pressure from region 916(28) and will effect adjustment in the pressure of the sealing fluid within chambers 920(12a), 922(12b) accordingly to ensure that the pressure within region 916 (28) is contained. The control system 810 will proportionally split the required pressure differential between the different chambers 920(12a), 922(12b), thus ensuring that an appropriate cascading sealing chamber pressure is established and maintained.

It should be noted that the control system is arranged to bias the pressure within the sealing assembly 914 to be greater than that in region 916(28). This bias may be achieved by a biasing arrangement, such as arrangement 76 described above with reference to FIG. 3. This bias may therefore permit the sealing assembly 914 to continuously develop an over-pressure against the mud pressure within region 916(28).

It should be understood that the various embodiments described above are merely exemplary and that various modifications may be made thereto without departing from the scope of the present invention.

For example, in some embodiments described above separate devices are provided to permit the pressure at a target location to be both increased and decreased. However, a single device may be provided to accommodate both rising and falling pressures. For example, the check valve arrangement (48, 50, 52, 54) within the described pump 30 may be modified to permit controlled relief of pressure.

Similarly, a modified version of the compensator relief valve (102) may be used to allow the control of an input pressure from an external source allowing the compensator device to perform both a rising and falling control of pressure

Additionally, embodiments of the present invention may include any number and combination of pumps and compensators, or single dual functioning devices, to modulate the pressure at any number of locations.

Furthermore, in each embodiment described above the control device 20 is arranged to monitor pressure at an external reference location. However, the control device may be configured to monitor an internal pressure, which may be, for example, electronically stored on the control device.

Further, the control device and variable controller may be provided as a single component.

Additionally, the pumps and compensators in the exemplary embodiments are defined by piston pumps. However, rotodynamic arrangements may be used, which me be electrically drive, fluid driven or the like.

It should be noted that although the various embodiments defined above relate to controlling pressure at a target location, the present invention may be used to also, or alternatively, supply the product fluid to the target location.

1. A pressure control system comprising:
a pressure modulating arrangement adapted to be operated by a drive medium to modulate the pressure of a product fluid at a target location towards a target pressure; and
a control device configured to monitor at least one reference pressure and to control the drive medium being delivered to the pressure modulating arrangement in accordance with said at least one reference pressure.

2. The system of claim 1, configured to modulate the pressure at the target location to track at least one monitored reference pressure.

3. (canceled)

4. The system of claim 1, wherein the control device is configured to monitor at least one reference pressure at a reference location.

5. The system of claim 1, wherein the control device is configured to monitor the pressure at the target location, and to control the drive medium in accordance with the monitored pressure at the target location and a monitored reference pressure.

6. The system of claim 1, wherein the control device is configured to modify a monitored pressure in accordance with a desired bias.

7. The system of claim 1, comprising a variable controller configured to vary the drive medium being delivered to the pressure modulating arrangement.

8. The system of claim 7, wherein the variable controller is configured to be controlled by the control device.

9. The system of claim 1, wherein the control device is configured to generate a control output to permit appropriate control of the drive medium.

10. The system of claim 9, wherein the control device is configured to communicate the control output to a variable controller to permit appropriate control of the drive medium.

11. The system of claim 9, wherein the control output comprises at least one of an electrical signal and pressure signal.

12. The system of claim 9, wherein the control device is configured to generate a mechanical output to permit appropriate control of the drive medium.

13. The system of claim 12, wherein the control device comprises a mechanical assembly having a displaceable component configured to be displaced to control a variable controller.

14. The system of claim 13, wherein the displaceable component is configured to be displaced by exposure to at least one of a monitored reference pressure and a monitored pressure at a target location.

15. The system of claim 13, wherein the displaceable component is configured to be displaced by exposure to a pressure differential.

16. The system of claim 15, wherein the pressure differential is defined between a monitored pressure at the target location and a monitored reference pressure.

17. The system of claim 1, wherein the control device comprises a piston assembly having a displaceable piston component.

18. The system of claim 17, wherein the displaceable piston component comprises a first piston area configured for exposure to a monitored reference pressure, and a second piston area configured for exposure to a monitored pressure at the target location.

19. The system of claim 1, wherein the control device comprises a biasing arrangement configured to bias a displaceable component.

20. The system of claim 1, wherein the drive medium comprise a fluid, wherein the control device is configured to control a property of said fluid, such as fluid pressure, flow rate or the like.

21. (canceled)

22. The system of claim 1, wherein the pressure modulating arrangement is configured to increase the pressure at the target location.

23. The system of claim 1, wherein the pressure modulating arrangement is configured to decrease the pressure at the target location.

24. The system of claim 1, wherein the pressure modulating arrangement is positioned between a source of product fluid and the target location.

25. The system of claim 1, wherein the pressure modulating arrangement comprises at least one pressure modulating device.

26. The system of claim 25, wherein at least one pressure modulating device comprises a pump assembly.

27. The system of claim 25, wherein at least one pressure modulating device is actuated by a fluid drive medium and is configured to produce a product fluid outlet pressure.

28. The system of claim 27, wherein at least one pressure modulating device is configured to produce an outlet product fluid pressure which is greater or less than the drive fluid pressure.

29. The system of claim 25, wherein at least one pressure modulating device comprises a piston assembly configured to be driven by the drive medium.

30. The system of claim 29, wherein the piston assembly comprises a drive fluid chamber defining a fluid inlet in communication with the drive fluid, and also comprises a product fluid chamber defining a fluid outlet in communication with the target location.

31. The system of claim 30, wherein the piston assembly comprises a piston member configured to be displaced relative to said fluid chambers.

32. The system of claim 29, wherein the piston assembly is double acting, such that operation may be achieved in reverse directions.

33. The system of claim 29, wherein the piston assembly is arranged such that when the piston member strokes in a first direction product fluid pressure at the target location is increased, and when the piston member strokes in a second direction product fluid is drawn into the product fluid chamber.

34. The system of claim 31, wherein the piston assembly comprises first and second product fluid chambers, and the piston member comprises respective first and second product fluid piston areas.

35. The system of claim 34, wherein the piston assembly is arranged such that stroking of the piston member in a first direction causes the first product fluid chamber to receive product fluid and the second product fluid chamber to increase the pressure of the product fluid at the target location, and stroking of the piston member in a second, reverse direction causes the first product fluid chamber to increase the pressure of the product fluid at the target location and the second product fluid chamber to receive product fluid.

36. The system of claim 31, wherein the piston assembly comprises first and second drive fluid chambers, and the piston member comprises respective first and second drive fluid piston areas, wherein the first and second drive fluid piston areas are configured to be alternately exposed to drive fluid pressure.

37. The system of claim 25, wherein at least one pressure modulating device comprises a non-return arrangement configured to prevent release of pressure of product fluid from the target location.

38. The system of claim 25, wherein at least one modulating device comprises a pressure relief arrangement configured to selectively release pressure from a target location.

39. The system of claim 38, wherein the pressure relief arrangement is configured to be operated by a mechanical force provided by a piston assembly of at least one pressure modulating device.

40. The system of any preceding claim 1, wherein the pressure modulating arrangement comprises at least two pressure modulating devices.

41. The system of claim 40, wherein at least two pressure modulating devices are configured to receive a common drive medium.

42. The system of claim 40, wherein at least two pressure modulating devices are arranged in series.

43. The system of claim 40, wherein a first pressure modulating device is configured to establish a first product fluid pressure and communicate this to a second pressure modulating device, wherein the second pressure modulating device is configured to modify the pressure of the received product fluid to establish a second product fluid pressure.

44. The system of claim 25, wherein one or more pressure modulating devices are arranged to permit bypass of product fluid pressure.

45. The system of claim 1, wherein the target location comprises a single region.

46. The system of claim 1, wherein the target location comprises at least two regions.

47. The system of claim 46, wherein the pressure modulating arrangement comprises at least two pressure modulating devices, wherein one or more pressure modulating devices are configured to modulate the pressure at one region, and one or more other pressure modulating devices are configured to modulate the pressure at another region.

48. The system of claim 47, wherein a first pressure modulating device or devices are configured to establish a first product fluid pressure and communicate this to both a first region and a second pressure modulating device or devices, wherein the second pressure modulating device or devices are configured to modify the pressure of the received product fluid to establish a second product fluid pressure and communicate this to a second region.

49. The system of claim 1, configured for use in combination with a sealing assembly configured to seal a pressurised region.

50. The system of claim 49, wherein the sealing assembly comprises at least one sealing chamber configured to receive a sealing fluid at a desired pressure, wherein the pressure control system is configured for use in modulating the pressure of a sealing fluid within the at least one sealing chamber towards a target pressure.

51. The system of claim 49, wherein the sealing assembly comprises a plurality of sealing chambers, and wherein the pressure control system is adapted to modulate the pressure within each sealing chamber towards a target pressure.

52. The system of claim 51, configured to generate a staged pressure difference between two or more sealing chambers.

53. The system of claim 49, wherein the sealing assembly is configured for use in a drive assembly of a bore drilling platform.

54. A method of controlling the pressure of a product fluid at a target location, comprising:
communicating a pressure modulating arrangement with a target location;
monitoring at least one reference pressure and controlling a drive medium being delivered to the pressure modulating arrangement in accordance with said monitored reference pressure to permit the pressure modulating arrangement to modulate the pressure of the product fluid towards a target pressure.

55-58. (canceled)

59. A sealing apparatus comprising:
a sealing assembly comprising a sealing chamber;
a pressure modulating arrangement adapted to be operated by a drive medium to modulate the pressure of a sealing fluid within the seal chamber towards a target pressure; and
a control device configured to monitor at least one reference pressure and to control the drive medium being delivered to the pressure modulating arrangement in accordance with said at least one reference pressure.

60. (canceled)
